(19) United States
(12) Patent Application Publication
(10) Pub. No.: US 2016/0248623 A1
(43) Pub. Date: Aug. 25, 2016

(54) APPARATUS AND METHOD FOR TRANSMITTING ERROR OCCURRENCE INFORMATION TO RESPECTIVE END NODES TERMINATING PATHS

(71) Applicant: FUJITSU LIMITED, Kawasaki-shi (JP)

(72) Inventor: MASAHIKO MATSUURA, Kanazawa (JP)

(73) Assignee: FUJITSU LIMITED, Kawasaki-shi (JP)

(21) Appl. No.: 15/000,510

(22) Filed: Jan. 19, 2016

(30) Foreign Application Priority Data
Feb. 20, 2015 (JP) 2015-031618

(51) Int. Cl. H04L 12/24; H04B 10/038; H04Q 11/00; H04L 12/703; H04L 12/707

(52) U.S. Cl. CPC H04L 41/0686; H04L 45/28; H04L 45/22; H04Q 11/0066; H04L 41/0668; H04B 10/038; H04Q 2011/0081; H04Q 2011/0077

(57) ABSTRACT

An apparatus, through which a plurality of paths pass, includes a receiving port configured to receive packets transmitted through the plurality of paths. When an error is detected in a packet received via the receiving port, the apparatus performs a process of transmitting error information indicating occurrence of an error to respective end nodes terminating the plurality of paths, by using information on the plurality of paths.

### CROSS-REFERENCE TO RELATED APPLICATION

This application is based upon and claims the benefit of priority of the prior Japanese Patent Application No. 2015-031618, filed on Feb. 20, 2015, the entire contents of which are incorporated herein by reference.

### FIELD

The embodiments discussed herein are related to apparatus and method for transmitting error occurrence information to respective end nodes terminating paths.

### BACKGROUND

In recent years, the introduction of a reconfigurable optical add/drop multiplexer (ROADM) system has been advanced for constructing a transmission network of ultrahigh speed and high capacity. The ROADM system includes a plurality of packet transmission devices (hereinafter, referred to as “node”) which are connected with each other and formed into a ring shape or a mesh shape through an optical cable.

IP devices, connected to an Internet Protocol (IP) network, are connected to each node. IP devices connected to a ROADM system perform packet communication, using the ROADM system as a relay network.

Each node converts a packet input from the IP device into an optical signal of a predetermined wavelength, and transmits (adds) the optical signal to an optical network. Alternatively, each node converts the optical signal of a predetermined wavelength, which is retrieved (dropped) from the optical network, into a packet, and is able to transmit the packet to the IP device.

When end-to-end communication is performed between IP devices connected to the ROADM system, a path (a logical line) is set in advance between a node (a transmitting node) connected to an IP device transmitting a packet and a node (a receiving node) connected to an IP device receiving a packet. Packet switching on an optical network is not performed in units of packets, but rather is performed in units of paths, using a label value that is set in the path. A path is identified based on the label value.

The path, that is set in end-to-end (between IP devices), is capable of employing a redundant configuration. For example, when the optical network is ring-shaped, paths are set both in a clockwise route and a counterclockwise route, from the transmitting node to the receiving node (end nodes of the paths). The receiving node treats one of the clockwise path and the counterclockwise path as an active system, and treats the other one as a standby system. When a failure is detected in the active system, the receiving node switches the standby system into the active system.

As a failure detection method of an active system, there is a method in which control data for detecting a failure is transmitted to both clockwise and counterclockwise routes, and when the receiving node is not able to receive the control data, it is determined that a failure has occurred.

Japanese Laid-open Patent Publication No. 2012-70106 and Japanese Laid-open Patent Publication No. 2002-199042 are examples of the related art.

### SUMMARY

According to an aspect of the invention, an apparatus, through which a plurality of paths pass, includes a receiving port configured to receive packets transmitted through the plurality of paths. When an error is detected in a packet received via the receiving port, the apparatus performs a process of transmitting error information indicating occurrence of an error to respective end nodes terminating the plurality of paths, by using information on the plurality of paths.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a ROADM system;

FIG. 2 is a diagram illustrating an example of a path and label switching;

FIG. 3 is a diagram illustrating an example of redundancy of a path and communication monitoring using control data;

FIG. 4 is a diagram illustrating an example of a problem in communication monitoring using control data;

FIG. 5 is a diagram illustrating an example of a cut-through type;

FIG. 6 is a diagram illustrating an example of a network configuration in which a problem of the cut-through type occurs;

FIG. 7 is a diagram illustrating an extracted part of a ring network in FIG. 6;

FIG. 8 is an explanatory diagram illustrating a problem of an AIS system;

FIG. 9 is a diagram illustrating an example of a configuration of a node (packet transmission device) provided with an FCS error detection function, according to an embodiment;

FIG. 10 is a diagram illustrating an example of a configuration of a node (packet transmission device) provided with a route selection function of a path, according to an embodiment;

FIG. 11 is a diagram illustrating an example of a data structure of a path DB, according to an embodiment;

FIG. 12 is a diagram illustrating an example of an operation table of packet filtering, according to an embodiment;

FIG. 13 is a diagram illustrating an example of a configuration of a discarded reservation packet counter, according to an embodiment;

FIG. 14 is a diagram illustrating an example of a frame format of MPLS-TP, according to an embodiment;

FIG. 15 is a diagram illustrating an example of a table representing label reserved values, according to an embodiment;

FIG. 16 is a diagram illustrating an example of a reservation label packet, according to an embodiment;

FIG. 17 is a diagram illustrating an example of an operation, according to an embodiment;

FIG. 18 is a diagram illustrating an example of a configuration of a network system, according to an embodiment;

FIG. 19 illustrates a configuration example of a node (a packet transmission device) used as nodes (1) to (10) illustrated in FIG. 18;

FIG. 20 illustrates an operation example of route switching in a user connection end point associated with the occurrence of an FCS error in the configuration of a network system illustrated in FIG. 18;

FIG. 21 illustrates an example of stored contents of a path DB of a relay node (a node (10) in FIG. 20) of a path;

FIG. 22 is a diagram illustrating an example of an operational flowchart for an FCS error detection process of a node, according to an embodiment;

FIG. 23 is a diagram illustrating an example of stored contents of the path DB of an end node (a node (6) in FIG. 20) of a path, according to an embodiment;

FIG. 24 illustrates a state of a discarded reservation packet counter of an IF card 101a (slot ID=10) and an IF card 101b (slot ID=11) of a node (6), according to an embodiment;

FIG. 25 is a diagram illustrating an example of a network configuration, according to an embodiment; and

FIG. 26 is a diagram illustrating an example of an operational flowchart for a route selection process, according to an embodiment.

### DESCRIPTION OF EMBODIMENTS

Each node in the ROADM system performs error checking for a packet to be relayed. Typically, the node computes a checksum for the data portion of the packet, and compares the checksum with the pre-calculated checksum value given to the packet. When the checksums do not match, the node determines that the packet contains an error. The error is referred to as a frame check sequence (FCS) error. Generally, a packet in which the FCD error has been detected is discarded by the node.

For this reason, even if more FCS errors occur in the route of the active system than in the route of the standby system, in a situation where the control data is normally received at the receiving node, the switching of the active system is not implemented. As a result, this causes a problem in that the use of a poor quality route is continued. In view of this, a method is considered in which the node relaying the packet does not detect the FCS error, or even if the FCS error is detected, the node relaying the packet does not discard the packet. In this case, the receiving node is able to perform the switching of the active system of the path, in view of the occurrence of the FCS error.

However, there is a case in which a plurality of paths are set on the route (physical line) of the active system. In this case, when the FCS error is detected in one of the plurality of paths, the FCS error is not less likely to occur on the remaining path.

In the above method, the end node of a path, for which the FCS error has been detected, is able to recognize the FCS error related to the path, but is not able to notify end nodes in the rest of paths of the occurrence of the FCS error.

Embodiments are intended to be capable of notifying each of end nodes terminating a plurality of paths passing through a node at which occurrence of a packet error has been detected, of the occurrence of the packet error.

Hereinafter, embodiments of the present disclosure will be described with reference to the drawings. The configurations of the embodiments are illustrative, and the present disclosure is not limited to the configurations of the embodiments.

Related Technique

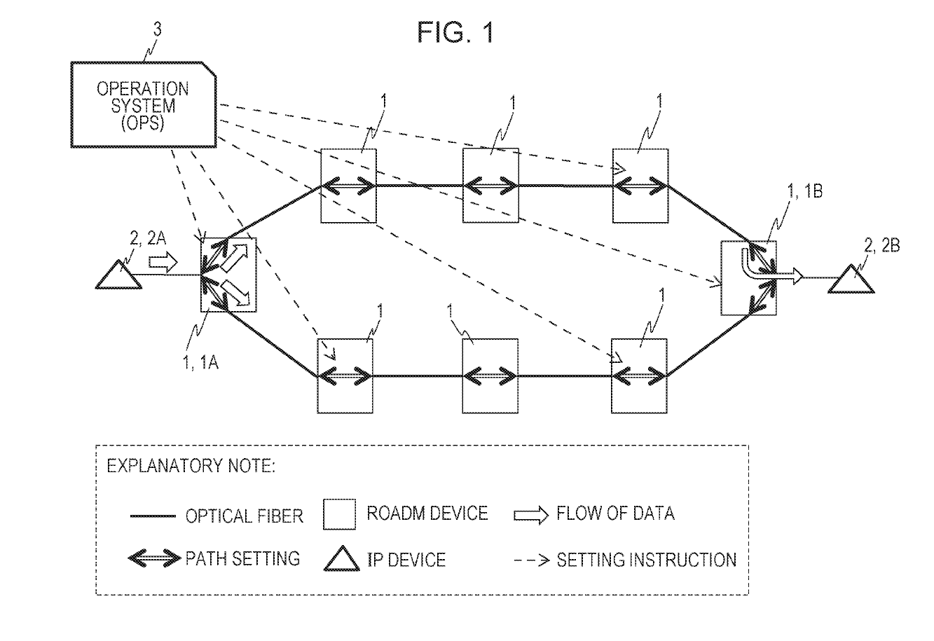

Hereinafter, a related technique of a network system according to an embodiment will be described. FIG. 1 illustrates an example of a ROADM system. In the example illustrated in FIG. 1, a plurality of nodes 1 (packet transmission devices) are connected in a ring shape through an optical cable (optical fiber). An external IP device (core router and the like) 2 may be connected to each node 1.

In the example illustrated in FIG. 1, an IP device 2A is connected to a node 1A, and an IP device 2B is connected to a node 1B. Further, each node 1 is connected to an operation system (OPS) 3 through a communication line. The OPS 3 is a server that sets a path for exchanging a signal in each node 1, and manages the paths in an integrated fashion.

Each node 1 may extract (referred to as Drop) a signal of a certain wavelength from an optical cable (ring), and insert (referred to as Add) a signal of a certain wavelength. Therefore, since electrical-optical conversion for extraction and insertion of a signal is unnecessary, high-speed switching is possible.

Further, the switching is not performed in units of packets, but a path for exchanging signals is set in the ROADM system. For example, in a mode called a multi-protocol label switching-transport profile (MPLS-TP) switch, a label is assigned to packets passing through the path, and switching by the label is performed, so as to realize high-speed switching.

The path is managed by the OPS 3 in an integrated fashion. The OPS 3 sends an instruction of a path to each node 1. Each node 1 sets a path for hardware provided in the node 1. Thus, a path is generated in end-to-end.

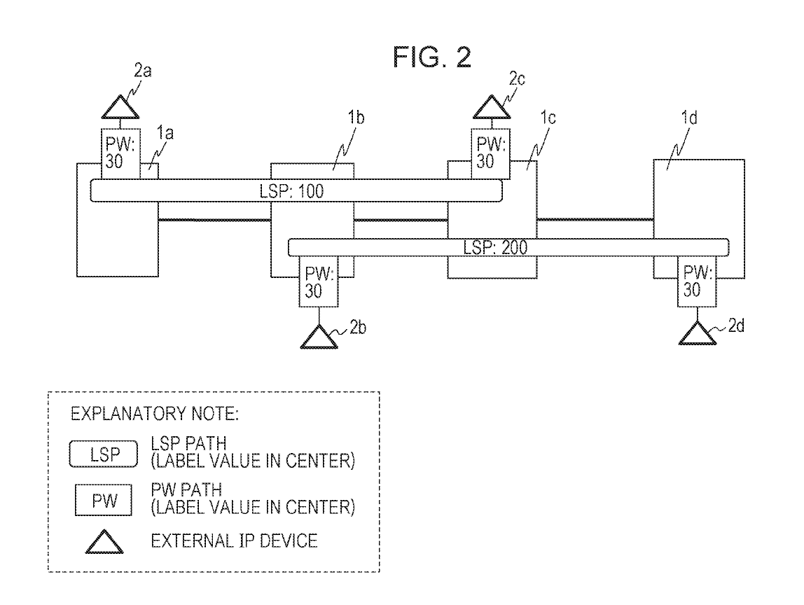

FIG. 2 is an explanatory diagram of a path and label switching. In FIG. 2, nodes 1a, 1b, 1c, and 1d are connected through an optical fiber. Corresponding IP devices 2a, 2b, 2c, and 2d are respectively connected to the nodes 1a, 1b, 1c, and 1d. FIG. 2 illustrates a method in which respective paths are set between the IP device 2a and the IP device 2c, and between the IP device 2b and the IP device 2d.

In the MPLS-TP, a path is formed by a channel called pseudo wire (PW) and a path called label switched path (LSP). The PW has a label value for identifying a user (IP device). The LSP has a label value for identifying a path.

In the example illustrated in FIG. 2, a path (referred to as a path 1) including a PW of a label value “30” and an LSP of a label value “100” is set between the IP device 2a and the IP device 2c. A path (referred to as a path 2) including a PW of a label value “30” and an LSP of a label value “200” is set between the IP device 2b and the IP device 2d.

Each of a node 1b relaying the path 1 and a node is relaying the path 2 performs switching by referring to only a label value (“100” or “200”) of the LSP, among the PW and the LSP. Thus, fast signal transmission is realized.

In an end node of a path, the label value (“30”) of the PW is also referred to. A user (an IP device) is identified by referring to the label value of the PW. For example, the node is which is an end node of the path 1 (LSP “100”) determines that the destination of a packet is the IP device 2c, by referring to the label value “30” of the PW, and transmits a packet received from the IP device 2a to the IP device 2c. Further, the node 1d which is an end node of the path 2 (LSP “200”) determines that the destination of a packet is the IP device 2c, by referring to the label value “30” of the PW, and transmits a packet received from the IP device 2b to the IP device 2c. Thus, data transmission of end-to-end (the IP device 2a to the IP device 2c, and the IP device 2b to the IP device 2d) is realized.

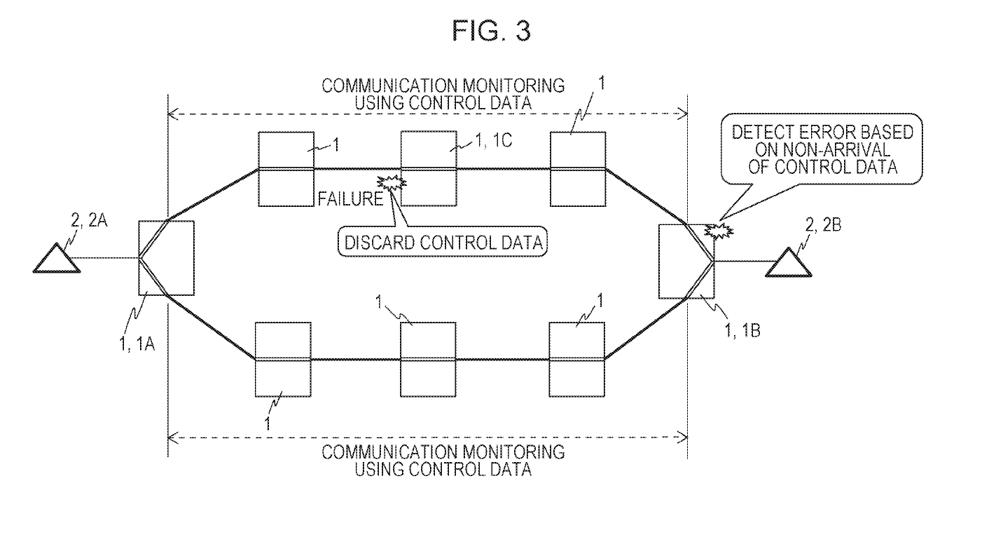

Further, with respect to the end node of a certain path, it is possible to adopt a redundant configuration for the certain path, by setting another path along another route, through which signals reach, different from the route of the certain path. For example, as illustrated in FIG. 3, a path (referred to as a first path) is set through which a packet reaches the node 1B (end node) from the node 1A (start node) through a clockwise route (on the upper side in FIG. 3). Meanwhile, a path (referred to as a second path) is set through which a packet reaches the node 1B (end node) from the node 1A (start node) through a counterclockwise route (on the lower side in FIG. 3).

Causing the node 1A to transmit the same packet through both the first path and the second path allows the node 1B to receive the same packet that is transmitted through the first path and the second path. This causes the paths between the node 1A and the node 1B to be redundant. The node 1B regards one of the first path and the second path as an active route, and regards the other one as a standby route. Then, the node 1B sends the packet received from the active route to the IP device.

For each of the first path and the second path, the node 1A transmits control data for communication checking to the node 1B. The node 1B monitors the communication through the first path and the second path by determining whether or not the control data is received from each of the first path and the second path. For example, when a failure occurs on the input side of the node 1C, and the control data is discarded, the node 1B is not capable of receiving control data from the first path. In this case, the node 1B determines that the communication through the first path is NG, and switches the active route to the second path. Thus, a system resisting a failure is realized.

Data flowing through the path on the network is converted into individual packets by a node. Each packet is subjected to error checking by hardware of a physical layer in the port circuit provided in the node. Specifically, the hardware in the port circuit calculates the checksum, from the data portion in the packet input to the node. The hardware compares the calculated checksum with a checksum which is beforehand calculated and assigned to the packet. When they are different, an error is mixed in the data portion, and thus the hardware discards the packet. Hereinafter, such abnormality is referred to as a frame check sequence (FCS) error.

The main factors of the occurrence of the FCS error include degradation of a physical cable, a change in characteristics such as a temperature, a characteristic change due to dirt and reflection of a signal receiving end face, and temporary deterioration in optical signals due to noise mixed in the circuit and the like. It is understood that an error may commonly occur due to these physical factors, and the level of the communication quality is determined depending on the error.

In general, it is said that the desired value of a bit error rate (BER) on Ethernet (registered trademark) is 10×10⁻⁹ (an error of one bit is input to one billion bits of error). However, along with an increase in the capacity of the network (introduction of 100G Ethernet (registered trademark)), the actual state of a technique reaches the level of 10×10⁻¹¹ (one of 100 billion bits) or 10×10⁻¹² (one of 1 trillion bits).

In the construction of a system of preparing the active route and the redundant route, and selecting a route having better transmission quality of a signal, at present, it is not possible to select a route having less frequency of occurrence of an FCS error as the active route.

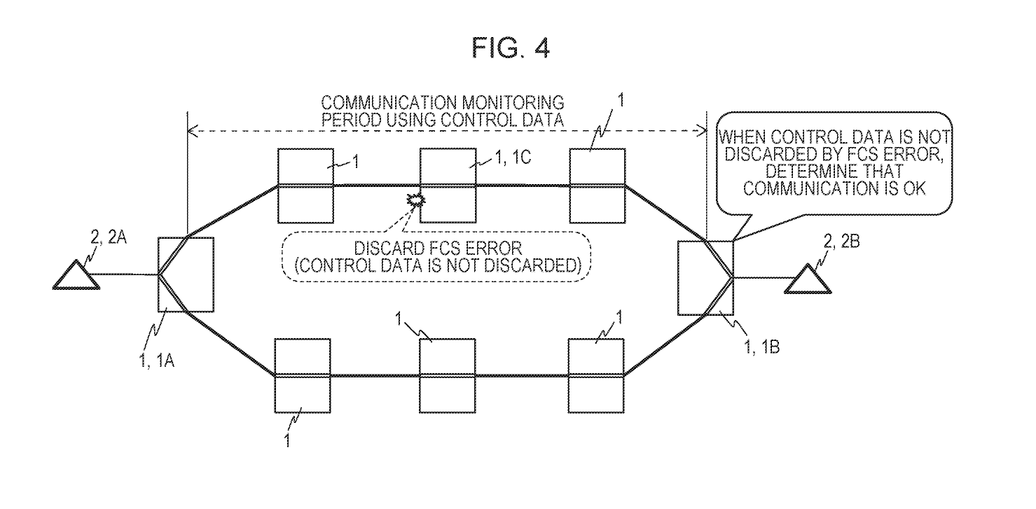

Because the FCS error is an error of a very low frequency error, even if the FCS error actually occurs, when the control data for communication monitoring is not discarded due to the FCS error, the node on the receiving side that performs the route selection determines that there is no problem in communication. Therefore, it is not possible to recognize the FCS error (see FIG. 4). In addition, when a packet with an FCS error is discarded by a device from which the FCS error is detected according to the normal provision, the node on the receiving node is not capable of detecting the occurrence of an FCS error.

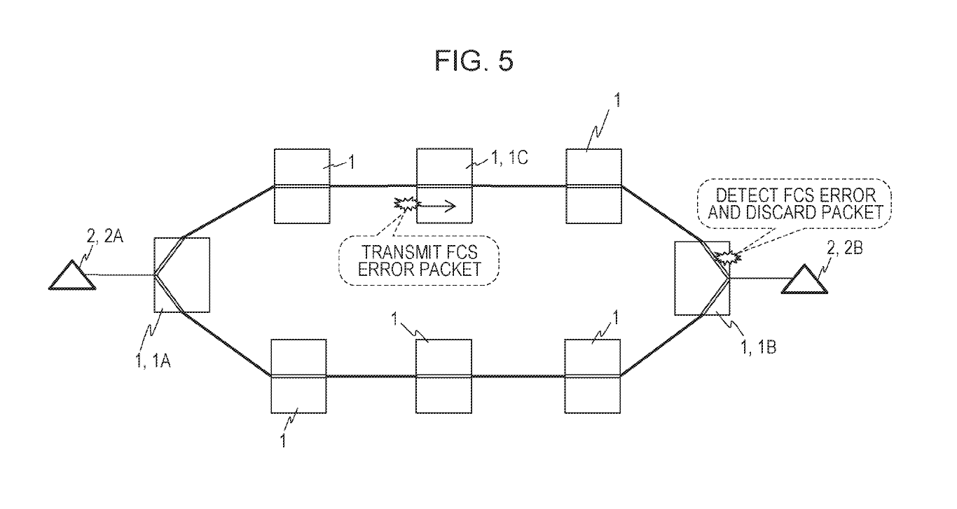

For the above problems, it is conceivable to use a node provided with a cut-through type of hardware that does not detect an FCS error. As illustrated in FIG. 5, the checking of the FCS error is not performed, and a packet is transmitted as it is, in the cut-through type. Incidentally, it is also considered as the cut-through type in which the checking of the FCS error is performed but the packet is transmitted as it is, even if the FCS error is detected.

In the case of employing the cut-through type and the like, a packet containing the FCS error reaches the node 1B (the end node in the path) that performs the route selection. The node 1B performs checking of the FCS error, and when the FCS error is detected, it is possible to perform the switching of the active route, in response to the detection of the FCS error.

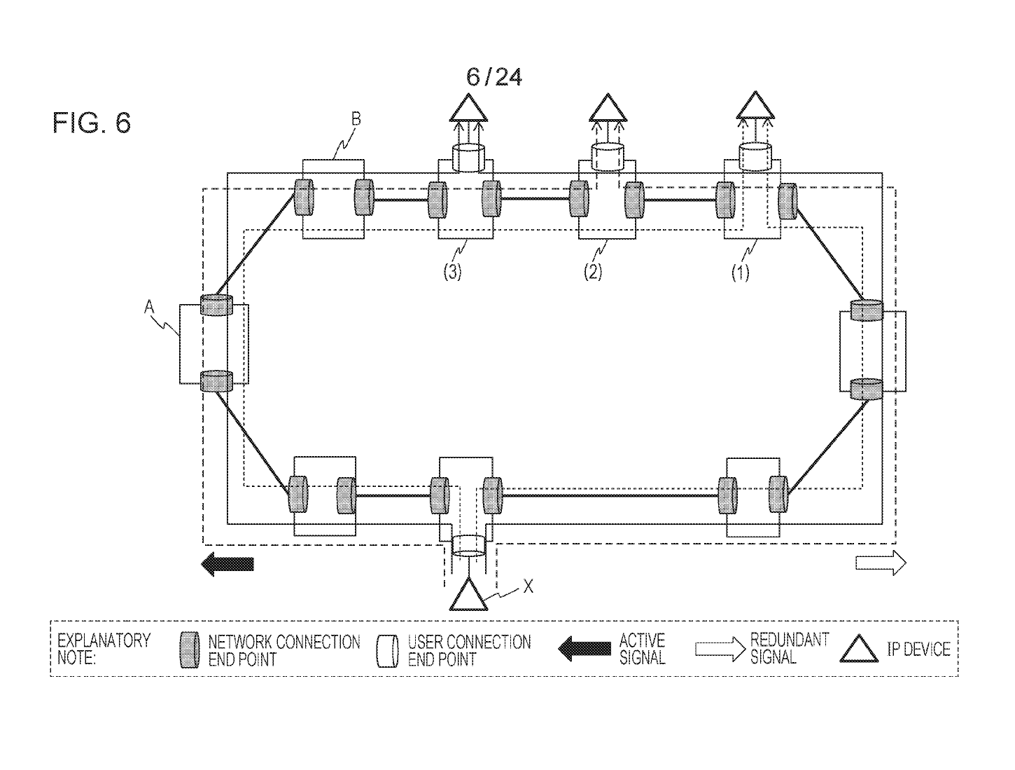

However, in the network configuration as illustrated in FIG. 6, the following problems occur. In the example of FIG. 6, a ring network is formed in which a plurality of nodes are connected in a ring shape through an optical cable. The plurality of nodes includes nodes to which IP devices are respectively connected. Paths are set which have a redundant configuration in which a node connected to one (IP device X) of the plurality of IP devices, and a node (1), a node (2), and a node (3) to which other IP devices are respectively connected. In FIG. 6, the paths having the redundant configuration are respectively indicated by respective arrows of a solid line, a dashed line, and a fine broken line. With respect to each redundant path, a signal flowing through a clockwise active route is an active signal, and a signal flowing through a counterclockwise redundant route is a redundant signal.

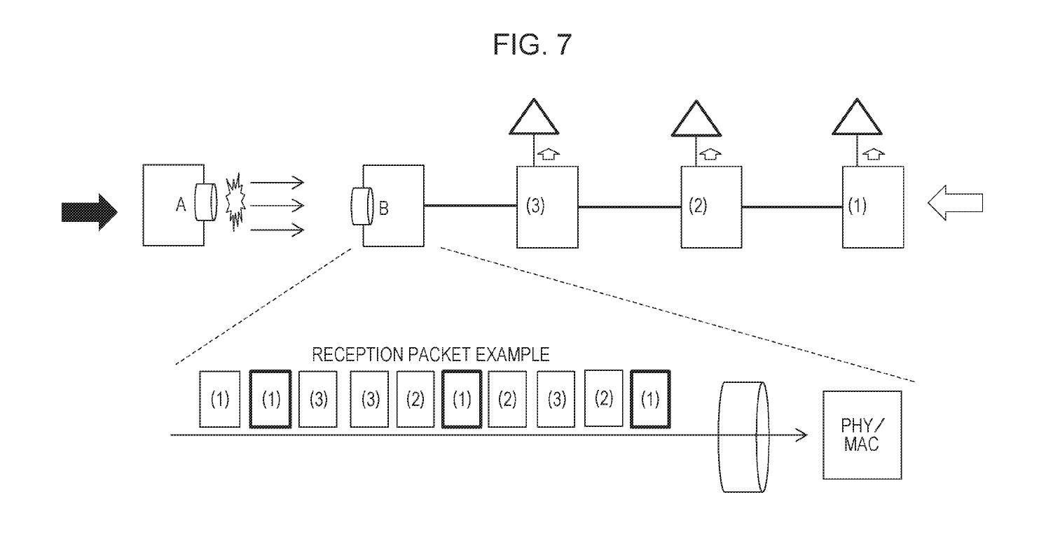

FIG. 7 is a diagram illustrating an extracted part of a ring network in FIG. 6. In FIG. 6, a node A, a node B, a node (1), a node (2), and a node (3), which are connected through an optical cable, are illustrated. IP devices are respectively connected to the node (1), the node (2), and the node (3) (see FIG. 6).

Each of the node (1), the node (2), and the node (3) receives an active signal reaching from the left side in FIG. 7, and a redundant signal reaching from the right side in FIG. 7, and transmits a signal with better quality to an IP device. FIG. 7 illustrates a packet that is received by the node B, in a case where signal loss occurs, and an error is mixed in a packet, in a transmission path between the node A and the node B.

In the example illustrated in FIG. 7, among packets received at the node B (illustrated as a plurality of rectangles which are arranged in series), it is assumed that an error is mixed in the packet addressed to the node (1) (see rectangles of a thick line), and an error is not mixed in the packets which are respectively addressed to the node (2) and the node (3).

In such a case, when the node B cuts through the FCS error, the FCS error is detected by the node (1). In this case, the node (1) is switched to the state where a redundant signal is treated as an active signal, in response to the detection of the FCS error in the active signal. In contrast, since the FCS error is not detected in each of the node (2) and the node (3), a state where the node (2) and the node (3) select the active signal (on the left side) is maintained.

However, the active signals addressed to the node (2) and the node (3) flow through the same physical line as the active signal of the node (1) having detected FCS error. Therefore, an error is not unlikely to be mixed into the active signals addressed to the node (2) and the node (3). Therefore, the node (2) and the node (3) are not able to perform normal signal selection (signal quality determination).

Originally, when the node B detects the FCS error, it is preferred that the node (1), the node (2), and the node (3), which are the end nodes of the path related to the packets received by the node B, are notified of the error. This allows signal switching determination to be performed not only in the node (1), but also in each of the node (2) and the node (3). However, there is no such mechanism at present.

As another method, there is a method (referred to as AIS system) in which the node that has detected the FCS error notifies a node that performs route selection of a signal error (for example, AIS: alarm indication signal, or the like). In the AIS system, the FCS error is periodically monitored for each node. The node that has detected a certain number of FCS errors transmits the AIS signal indicating a signal error to a node that performs the route selection. The node which receives the AIS signal switches the route.

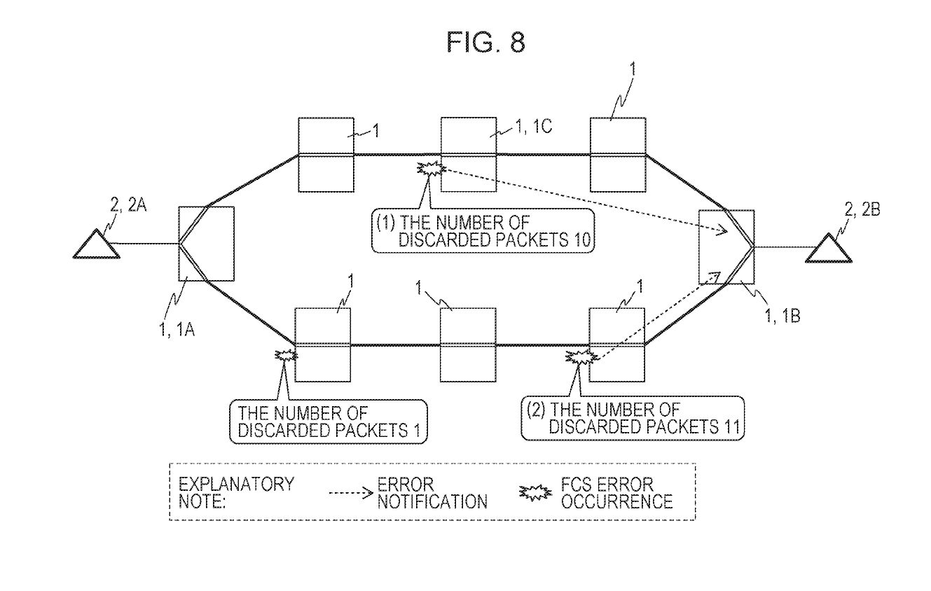

There is a problem in how many FCS errors the AIS system treats as a signal error. For example, as illustrated in FIG. 8, in the configuration of the same network system as FIG. 3, it is assumed that an AIS signal is transmitted when ten or more packets are discarded due to the FCS error within a certain period. In other words, it is assumed that an error is notified when the number of discarded packets due to FCS error in one cycle exceeds 10.

In this case, when the number of discarded packets in one cycle is nine or less, the AIS signal is not transmitted. Therefore, the number of discarded packets as mentioned above is not used for route switching determination at the node 1B. In addition, when a signal error occurs in both the active route and the redundant route (the AIS signal is sent from both the active route and the redundant route), route switching is not possible.

For example, as illustrated in FIG. 8, when comparing the number of discarded packets in the active route (the upper route in FIG. 8) with the number of discarded packets in the redundant route (the lower route in FIG. 8), the number of discarded packets in the upper route is 10, whereas the number of discarded packets in the lower route is 11. That is, the quality of the upper route is better than the quality of the lower route. However, when the notification timing of the error (AIS signal) from the upper route is earlier than the notification timing of the error from the lower route, the following problems occur.

The node 1B switches the active route to the lower route due to the error received from the upper route. Thereafter, switching of the active route to the upper route is tried due to the error received from the lower route. However, since the upper route has already been notified of an error, it is not possible to perform the switching. As a result, the selected state of the lower route with poor quality is maintained.

In the embodiments described below, a network system and a packet transmission device which are capable of solving the above problems will be described.

### Embodiment 1

Hereinafter, an embodiment will be described. The embodiment describes a packet transmission device (node) applicable to a ROADM system using MPLS-TP, as an example. However, the application scope of the present disclosure is not limited to the ROADM system using MPLS-TP.

Configuration of Node

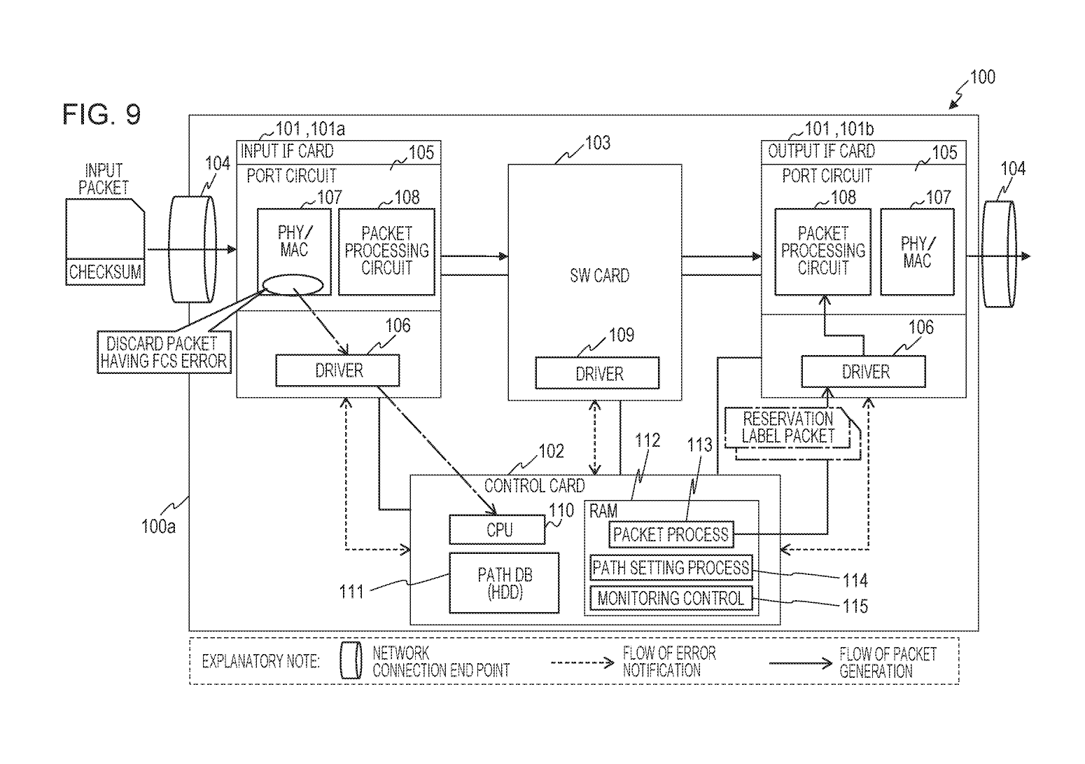

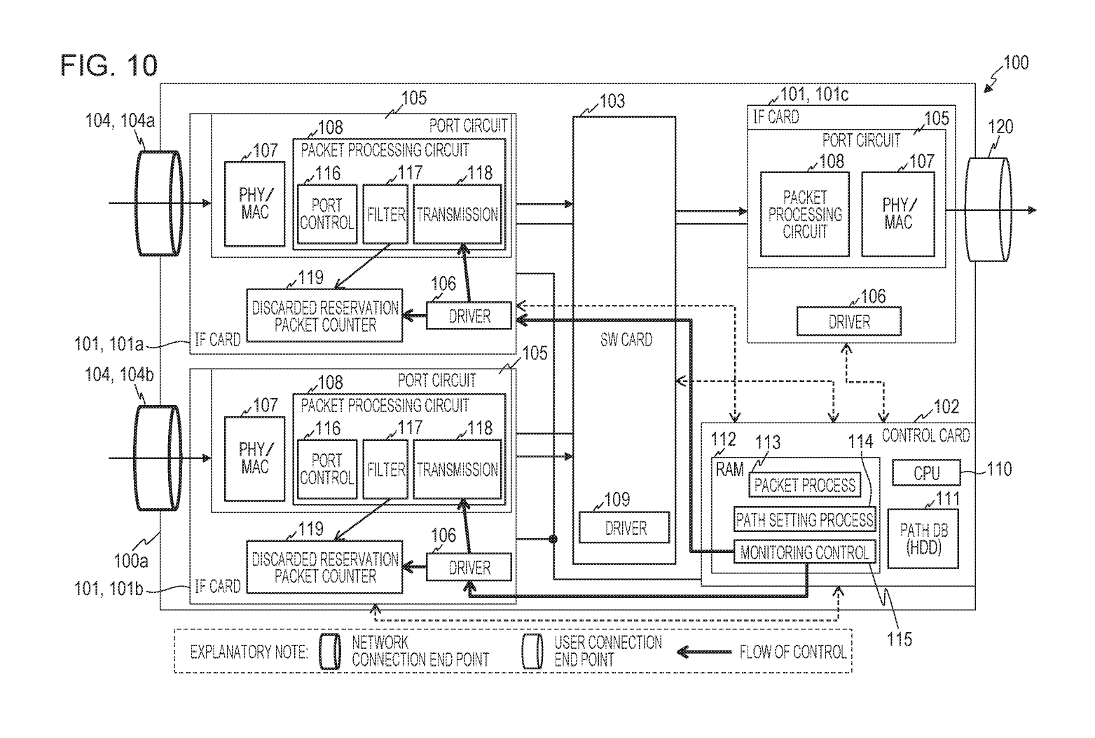

Hereinafter, the configuration of a node according to Embodiment 1 will be described. FIG. 9 illustrates a configuration example of a node (packet transmission device) provided with an FCS error detection function according to the embodiment. FIG. 10 illustrates a configuration example of a node (packet transmission device) provided with a route selection function of a path. However, the configuration illustrated in FIG. 9 and the configuration illustrated in FIG. 10 may be provided in one node. The FCS error detection function is used at a node located in the middle (between the start and the end) in the path. Meanwhile, the route selection function is used at a node (end node) located in the end in the path. However, the node exclusively operating as a relay node has a configuration illustrated in FIG. 9, and the node exclusively operating as an end node has a configuration illustrated in FIG. 10.

A packet transmission device that acts as a node includes a housing called a chassis, and a card with a predetermined function. The chassis includes a plurality of slots for mounting cards, and a wire connection device (a wiring backboard: BWB (not illustrated)) electrically connecting the cards which are mounted (inserted) in the slots.

As illustrated in FIG. 9 and FIG. 10, the cards mounted in the chassis 100a includes an interface card (IF card) 101 that transfers the packet signal, and a control card 102 controlling the interface. In addition, the cards includes a switching card (SW card) 103 that dynamically transfers a packet that has been input from a certain IF card 101 to a target IF card 101.

In FIG. 9, an IF card 101 (101a) that operates as an input IF responsible for an interface function with an optical cable (network), and an IF card 101 (101b) that operates as output IF are illustrated. Each IF card 101 includes a port circuit 105, which is connected to the optical transmitter and receiver module 104, and a driver 106.

The optical transmitter and receiver module 104 is connected to the optical cable to be connected to the adjacent node, converts the optical signal transmitted through the optical cable (the optical signal into which packets of a plurality of paths are multiplexed) into an electrical signal, and inputs the electrical signal to the port circuit 105. In addition, the optical transmitter and receiver module 104 converts packets (electrical signals) input from the port circuit 105 into an optical signal, and sends the optical signal to the optical cable. The optical transmitter and receiver module 104 function as a network connection end point. The optical cable is an example of the “physical line”.

The port circuit 105 includes a receiving port of the packets which are received from the optical transmitter and receiver module 104, a PHY/MAC circuit 107, and a packet processing circuit 108. The receiving port receives packets respectively flowing through respective paths (a plurality of paths) that are relayed by the node 100. The PHY/MAC circuit 107 performs a process for the physical layer and a media access control (MAC) layer for the electrical signals (packets) received from the optical transmitter and receiver module 104 at the receiving port. Thus, the packets of each path are obtained. Checking of the FCS error for a packet is executed by the PHY/MAC circuit 107. The packet processing circuit 108 performs a predetermined process on the packet that has been input from the PHY/MAC circuit 107.

The SW card 103 includes a driver 109. The SW card 103 outputs packets input from the IF card 101a on the input side to the IF card 101 on the output side according to the label value included in the packets. For example, packets are input to the IF card 101b.

The IF card 101b of the output IF also includes the port circuit 105 and the driver 106. The port circuit 105 includes a PHY/MAC circuit 107, and a packet processing circuit 108. The packet processing circuit 108 performs a predetermined process on packets input from the SW card 103 or the driver 109. The PHY/MAC circuit 107 performs a process for the PHY and MAC layer for the packets, and inputs the packets to the optical transmitter and receiver module 104. The optical transmitter and receiver module 104 converts the packets (electrical signals) into an optical signal, and sends the optical signal to the optical cable (network).

The control card 102 includes a central processing unit (CPU) 110, a hard disk drive (HDD) 111, and a random access memory (RAM) 112. The HDD 111 and the RAM 112 are an example of “storage device” and “computer-readable recording medium”.

The HDD 111 is an example of the auxiliary storage device or a non-volatile storage medium, and may be at least one of a solid state drive (SSD), an electrically erasable programmable read-only memory (EEPROM), and a flash memory. In addition to the HDD and the RAM, at least one of these auxiliary storage devices or other storage media such as a read only memory (ROM) may be provided.

The HDD 111 stores a path data base (path DB). The HDD 111 stores a program executed by the CPU 110. The RAM 112 is used as a storage area of the CPU 110 and the work area of data. The CPU 110 develops programs stored in the HDD 111 to the RAM 112 and executes the programs. Thus, the CPU 110 executes a packet process 113, a path setting process 114, a monitoring control 115, and the like. The CPU 110 is an example of “processor”, “controller”, “control device”, and “control unit”.

The CPU 110 of the control card 102 receives a path setting instruction from the OPS (see FIG. 1), and stores path information in the path DB stored in the HDD 111. In addition, the CPU 110 performs a path setting process 114 based on the path information, and sets a path in the IF card 101 and the SW card 103. The control (path setting) of the IF card 101 and the SW card 103 is performed by the CPU 110 providing a path setting control signal to the driver 106 and the driver 109. Thus, the node 100 enters a state capable of transferring data (packet transmission).

As illustrated in FIG. 10, the node 100 includes the following components in addition to the components illustrated in FIG. 9. In other words, the node 100 includes at least three IF cards 101. The node 100 illustrated in FIG. 10 includes an IF card 101a, an IF card 101b, and an IF card 101c, as the IF card 101.

The IF card 101a operates as an input IF that terminates one of the redundant paths. The IF card 101b operates as an input IF that terminates the other one of the redundant paths. The IF card 101c operates as an interface with a user (IP device). The IF card 101a is an example of “first receiver”, and the IF card 101b is an example of “second receiver”.

The packet processing circuit 108 of the port circuit 105 in each of the IF card 101a and the IF card 101b includes a port control circuit 116, a filtering unit (filter) 117, and an in-device transmission circuit 118. Further, each of the IF card 101a and the IF card 101b includes a discarded reservation packet counter 119. The port circuit 105 of the IF card 101c is connected to the IP device through user connection point 120. The discarded reservation packet counter 119 is an example of a “memory”.

Operation Example

Next, an example of an FCS error detection operation by the node 100 will be described with reference to FIG. 9. The PHY/MAC circuit 107 of the IF card 101a illustrated in FIG. 9 performs FCS error checking of a packet input from the optical transmitter and receiver module 104. When an FCS error is detected, the PHY/MAC circuit 107 discards the packet.

The driver 106 of the IF card 101A monitors the discarded packet counter (not illustrated) included in the IF card 101A, and notifies the CPU 110 of the control card 102 of interruption, every time the counter value (the number of discarded packets (error occurrence count)) increases.

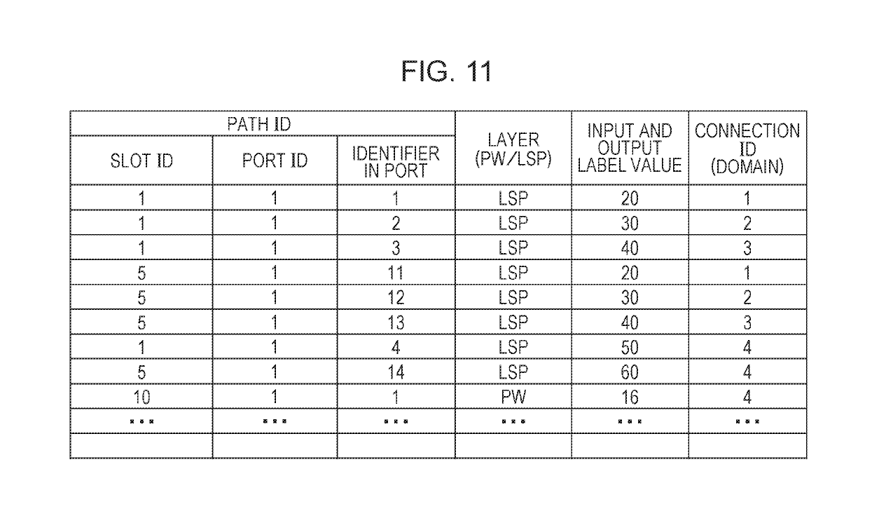

The CPU 110 that has received an interruption searches the path DB for a path set on the port for which the FCS error has been detected. FIG. 11 illustrates a data structure example of a path DB. As illustrated in FIG. 11, the path DB stores an entry for each path. In other words, the path DB stores a plurality of entries (records) each including “layer (PW/LSP)”, “input and output label value”, and “connection ID (domain)”, which are associated with a path ID. The path ID is an identifier of a path.

“Layer” indicates whether the information of the entry is information of the PW layer or information of the LSP layer, in the MPLS-TP. The input and output label value indicates a label value that is set in the path (LSP or PW). The connection ID indicates information identifying a domain to which the path belongs. When paths belong to the same domain, signals of the paths are transmitted through the same physical line.

In the example illustrated in FIG. 11, the path ID includes a slot ID, a port ID, and an identifier in a port (ID in a port). The slot ID is identification information of a slot to which the IF card 101 is inserted, and the port ID indicates the ID of a receiving port via which the packet is received. The identifier in the port is used to distinguish signals within the port.

Returning back to the process illustrated in FIG. 9, the CPU 110 searches the path DB for an entry with a path ID which has been notified by the interrupt. At this time, the CPU 110 also searches for an entry having the same “connection ID”. Thus, all the paths that are set to the receiving port via which the FCS error has been detected are retrieved from the path DB.

The CPU 110 performs the packet process 113, generates a reservation label packet for each path that is retrieved from the path DB, and requests the driver 106 of the IF card 101b of the output IF corresponding to the path to transmit the reservation label packet. The driver 106 controls the packet processing circuit 108 so as to input the reservation label packet from the port circuit 105 (IF card 101b) to the transmitter and receiver module 104. Thus, the reservation label packet is transmitted towards the end node of each path that has been retrieved from the path DB. The reservation label packet is an error notification for notifying the end node of occurrence of the FCS error on a certain path. The reservation label packet has a predetermined PW label value.

Next, an example of a route selecting operation by the node 100 will be described with reference to FIG. 10 The filter 117 in the packet processing circuit 108 of the IF card 101a checks a packet input from the PHY/MAC circuit 107, according to the operation table (stored in the port circuit 105) of packet filtering.

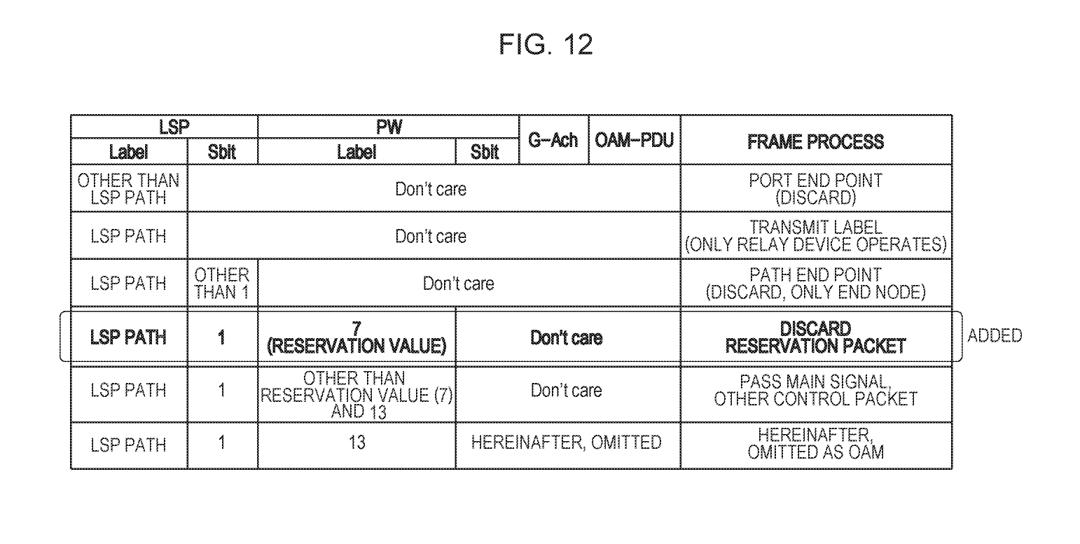

FIG. 12 illustrates an example of an operation table of packet filtering. As illustrated in FIG. 12, the operation table is a table in which the process contents are defined for packets (frames) that are transmitted through paths other than the LSP path and through the LSP path.

For example, port-terminating (discarding of the packet) is made for packets other than in the LSP path. Further, label transfer is performed for a packet in the LSP path (however, only the node relaying the path operates). In the embodiment, a packet is multiply-encapsulated by the LSP label and the PW label, and it is defined that the reservation packet is discarded when the PW label value is a “7” (reservation label value). Incidentally, the S (bottom of the stack) bit in FIG. 12 indicates whether or not the packet is multiply-encapsulated by a plurality of label fields.

When the PW label value in a packet is a predetermined reservation label value (for example, “7”), the filter 117 discards the packet (reservation label packet) according to the operation table. The filter 117 records the number of discarded packets in the discarded reservation packet counter 119.

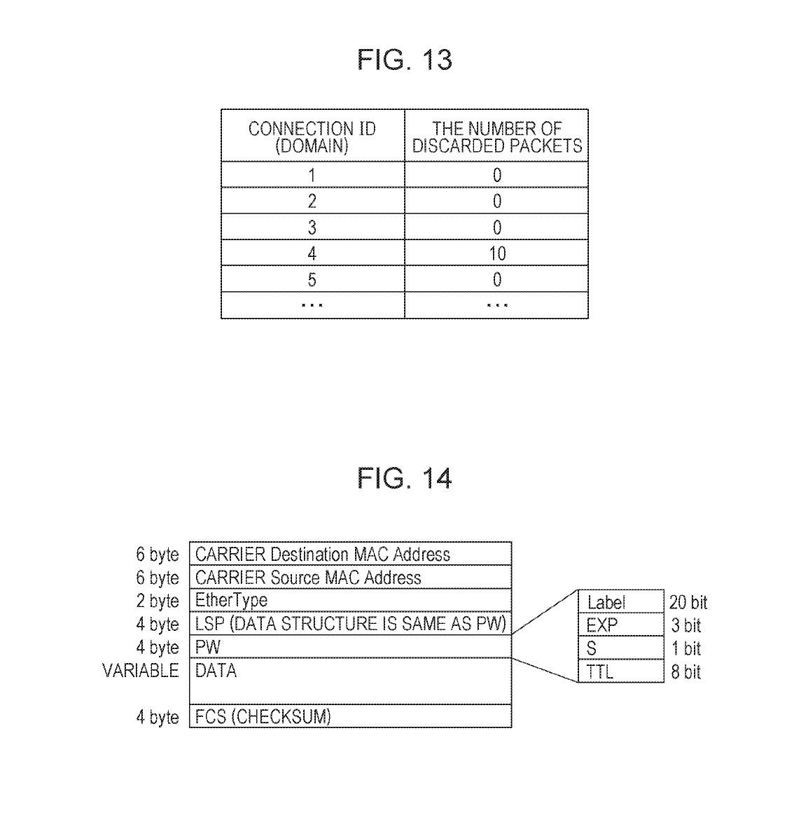

FIG. 13 illustrates a configuration example of a discarded reservation packet counter (counter) 119. The counter 119 is prepared, for example, for each path ID. The counter 119 stores the number (cumulative number) of discarded reservation label packets for each connection ID (domain: path). However, the number of discarded packets is reset whenever a predetermined time is elapsed. The filter 117 increments the number of discarded packets corresponding to the domain to which the discarded reservation label packet belongs.

The same operation is performed in the port circuit 105 of the IF card 101b, and the number of discarded packets of the domain corresponding to the counter 119 is increment every time the reservation label packet is discarded.

The CPU 110 of the control card 102 executes monitoring control 115, gives an instruction to the driver 106, and obtains the counter value of the counter 119 from the IF card 102a and the IF card 101b. The CPU 110 controls the transmission circuit 118 through the driver 106 so as to compare the number of discarded packets for each domain, and selects a signal from a route having a lower number of discarded packets.

For example, it is assumed that a signal (packet) received by the IF card 101a is selected as the active system, and a signal (packet) received by the IF card 101b is set as the redundant system (standby system). In this case, when the number of discarded packets in the active system is less than in the standby system, the selected state of the IF card 101a is maintained. In other words, the state is maintained in which the transmission circuit 118 of the IF card 101a transmits a packet to the SW card 103, and the transmission circuit 118 of the IF card 101b discards the packet.

In contrast, when the number of discarded packets in the standby system is less than the number of discarded packets in the active system, the CPU 110 instructs switching to the driver 106. Thus, the transmission circuit 118 of the IF card 101a discards the packet, and the transmission circuit 118 of the IF card 101b enters a state of transmitting a packet to the SW card 103. Thus, the route is switched to the system having a lower FCS error count.

Reservation Label Value

In addition, it is possible to employ the following configuration as the reservation label value. In other words, with respect to the label value that is defined in the RFC 3032 MPLS Label Stack Encoding, the value of up to 20 bits (0 to 1048575) is available.

FIG. 14 illustrates a frame format example of MPLS-TP. In a frame, data (data portion) is encapsulated in a PW label format, and is further encapsulated in an LSP label format. The destination MAC address, transmission source MAC address, and the Ethernet (registered trademark) type are given as the MAC header in front of the LSP label. In addition, FCS (checksum) is given as a trailer in the rear of the data portion. The MAC address of the end node is set in the destination MAC address.

The PW label field includes a label field, an S-bit field, a time to live (TTL), and the like. The PW label value is set in the label field. The LSP label field has the same data structure as the PW label field. Setting a predetermined label value as the PW label value allows the MPLS-TP frame to be used as the reservation label packet described above.

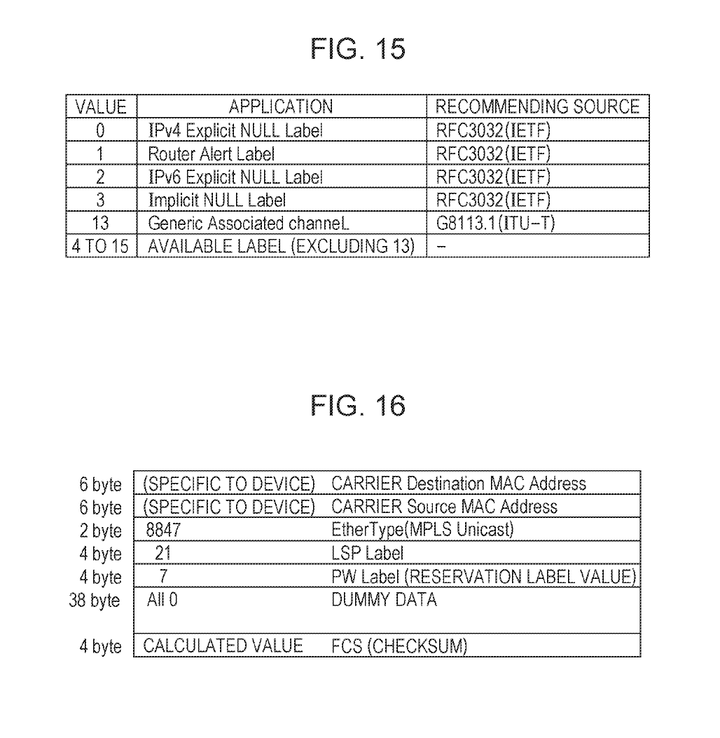

FIG. 15 is a table representing label reserved values. “0” to “15” have already been defined as the label reserved value. However, among the label reserved values “0” to “15”, the applications of the “0” to “3” and “13” have been determined, but the applications for “4” to “12”, “14” and “15” are not determined. Therefore, one of “4” to “12”, “14” and “15” may be used as a label value for notifying the FCS error.

In the example described above, the reservation label packet is defined using the PW label value “7”. FIG. 16 illustrates an example of a reservation label packet. However, a label value (“16” or more) outside the definition may be used as the reservation label value indicating the FCS error by setting the label value as a value which is not normally used.

Further, it is preferred to use “16” or “1048575(20)” as the label value, in terms of label management. This is because these values are normally not used in many cases when other existing devices (other vendors) coexist within the same network in the MPLS-TP network.

Effects of Embodiment 1

As described with reference to the related technique, the packet transmission device (node) was not able to notify the end node of the related path of the FCS error detected in the network. Therefore, it was not possible for each end node to perform route switching of the path in consideration of the number of FCS errors.

According to Embodiment 1, a reservation label packet (error notification) is generated for each of paths whose packets are received via the receiving port having a detected FCS error, and is notified to the end node of each path.

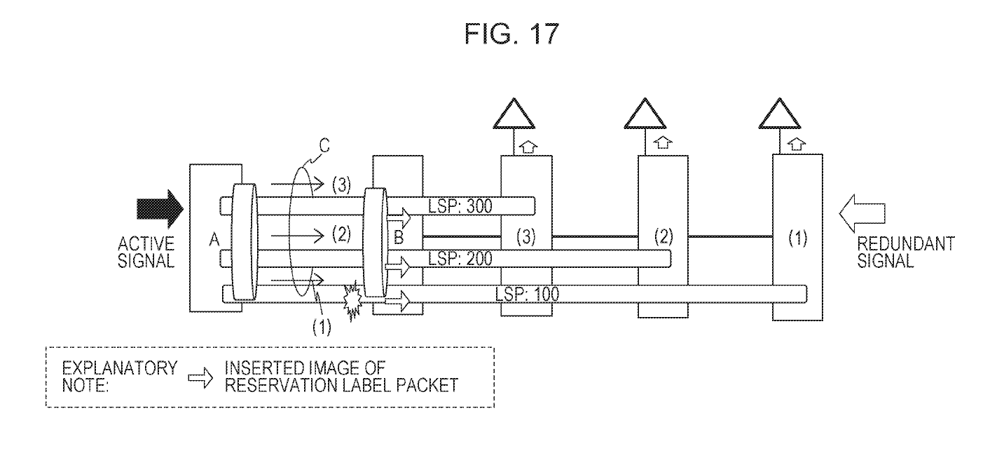

FIG. 17 is an explanatory diagram of an operation of Embodiment 1. FIG. 17 illustrates the same network configuration as the technique illustrated in FIG. 7. A path 1 (LSP “300”) is set between the node A and the node (3), a path 2 (LSP “200”) is set between the node A and the node (2), and a path 3 (LSP “100”) is set between the node A and the node (1).

The respective paths 1 to 3 are set on the optical cable (physical line) C connecting the node A and the node B, between the node A and the node B. A packet flowing through the respective paths 1 to 3 reaches the node B through the same physical line, and a packet of the respective paths 1 to 3 is received at a predetermined port of the node B.

When an error is mixed in the optical cable C between the node A and the node B, a reservation label packet is transmitted to the nodes (1) to (3) which are the end nodes of a plurality of corresponding paths 1 to 3. In other words, it is possible to notify each of the end nodes (1) to (3) of the respective paths of LSP “100”, LSP “200”, and LSP “300” whose packets are received via the same receiving port of the node B, of an FCS error. In this way, according to Embodiment 1, it is also possible to notify the end nodes of paths other than the path for which the FCS error has been detected, of the occurrence of the FCS error.

Further, each end node may select a route having less FCS errors as an active route, by route selecting operation. In other words, it is possible to perform the route selection in consideration of the occurrence of the FCS error. This allows highly accurate route switching.

### Embodiment 2

Next, Embodiment 2 will be described. Since the configuration of Embodiment 1 has common parts with Embodiment 2, a description regarding the common parts with Embodiment 1 will be omitted. Embodiment 2 represents the details of Embodiment 1.

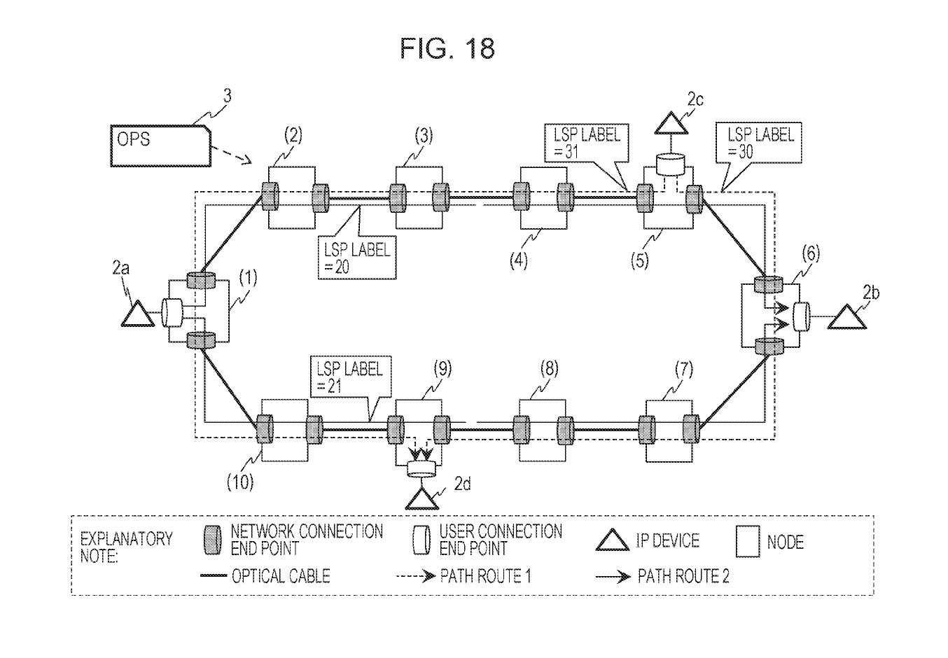

FIG. 18 illustrates a configuration example of a network system according to Embodiment 2. In a network system illustrated in FIG. 18, nodes (1) to (10) are connected in a link shape through an optical cable. Each of the nodes (1) to (10) has the configuration of the node 100 illustrated in FIG. 9 and FIG. 10.

Further, the IP device 2a is connected to the node (1), the IP device 2b is connected to the node (6), the IP device 2c is connected to the node (5), and the IP device 2d is connected to the node (9).

The OPS 3 sets a path having a redundant configuration in order to start a service (packet communication) between the IP device 2a and the IP device 2b. Thus, for example, a first path (LSP label value “20”) passing through the upper route (the node (1), the node (2), the node (3), the node (4), the node (5), and the node (6)) is set. Further, a second path (LSP label value “21”) passing through the lower route (the node (1), the node (10), the node (9), the node (8), the node (7), and the node (6)) is set.

The node (1) is an example of the start node of the paths (LSP “20” and LSP “21”), and the node (6) is an example of the end node of the paths (LSP “20” and LSP “21”). The node (1) transmits the same packet to two paths employing a redundant configuration. The node (6) selects one of the same packets received from the two paths, and transmits the selected packet to the IP device 2b.

Similarly, a path employing a redundant configuration is set between the IP device 2c and the IP device 2d. Specifically, a third path (LSP label value “30”) passing through the right route (the node (5), the node (6), the node (7), the node (8), and the node (9)) is set. A fourth path (LSP label value “31”) passing through the left route (the node (5), the node (4), the node (3), the node (2), the node (1), the node (10), and the node (9)) is set. The node (5) is an example of the start node of the paths (LSP “30” and LSP “31”), and the node (9) is an example of the end node of the paths (LSP “30” and LSP “31”).

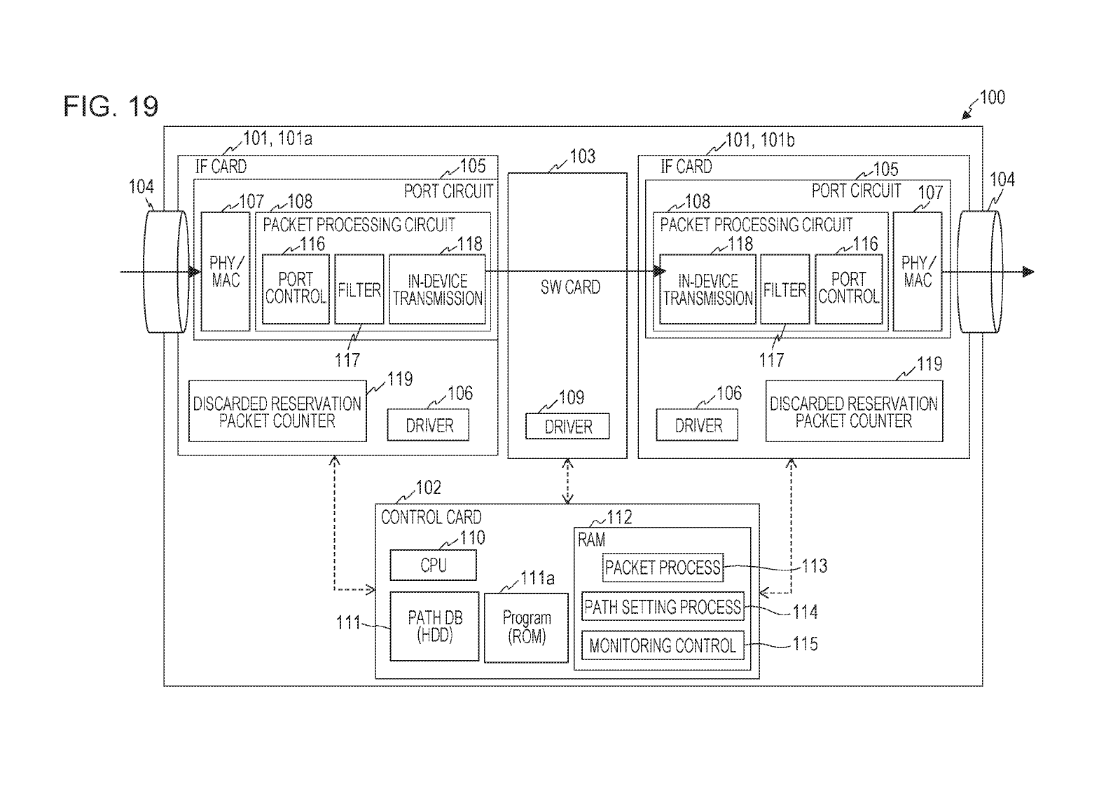

FIG. 19 illustrates a configuration example of a node (a packet transmission device) 100 used as nodes (1) to (10) illustrated in FIG. 18. Those different from Embodiment 1 (FIG. 9) are as follows. The control card 102 includes a ROM 111a storing a program. The packet processing circuit 108 includes a port control circuit 116, a filter 117, and an in-device transmission circuit 118.

The cards 101 to 103 are mounted in the chassis 100a, and are able to exchange control data with each other as indicated by the dotted arrows. In the control card 102, the program developed into the RAM 112 from the ROM 111a is executed by the CPU 110. The CPU 110 receives a path setting instruction from the OPS 3 as illustrating in FIG. 18. However, the operation of the OPS 3 may be performed by the CPU 110 executing the program. In other words, the OPS 3 may be mounted in the node 100.

The CPU 110 stores the path information that is included in the path setting instruction in the path DB of the HDD 111. The CPU 110 performs path setting process 114, and performs path setting by controlling the drivers 106 of the IF card 101a and 101b, and the driver 109 of the SW card 103.

In addition, the packet process 113 executed by the CPU 110 is a function that performs individual packet control. The generation of a reservation label packet and the instruction to the driver 1106 for insertion of the reservation label packet are made by the packet process 113. In the monitoring control 115 executed by the CPU 110, alarm monitoring, performance monitoring, and the switching control of each of the cards 101 to 103 are performed.

Each of the IF card 101a and the IF card 101b includes a port circuit 105. The port circuit 105 of the IF card 101a includes a receiving port that receives an electrical signal (main signal) from the optical transmitter and receiver module 104, and processes the electrical signal (main signal) received via the receiving port. The PHY/MAC circuit 107 extracts a packet from the electrical signal (main signal), and passes the extracted packet to the packet processing circuit 108.

The packet processing circuit 108 performs bandwidth control, such as quality of service (QoS) control, at the port control circuit 116. Thereafter, the packet processing circuit 108 determines the contents of the individual packet in the filter (packet filtering) 117, and process each packet in accordance with the conditions determined.

In Embodiment 2, the operation of the reservation label packet is newly added to the determination condition (see FIG. 12). In the filter 117, the packet that is recognized as the reservation label packet is discarded, and the number of discarded packets is recorded in the discarded reservation packet counter 119.

In contrast, when the determination result of the contents of a packet indicates that the packet is a data packet for transferring user data and the like, a predetermined type of information is given to the packet such that the transmission circuit 118 transfers the packet to a target IF card from the SW card 103. Then, the packet is sent to the SW card 103.

The SW card 103 sends the packet to the interface of the destination, based on the information given to the packet. In the port circuit 105 of the IF card 101b on the output side which receives the packet that has been transferred from the SW card of 103, the packet undergoes a process by the transmission circuit 118, a process by the filter 117, and a process by the port control circuit 116. Thereafter, the packet is transmitted from the PHY/MAC circuit 107 to the optical transmitter and receiver module 104. Thus, the optical signal that is converted from the packet is transferred to the adjacent device.

Note that the node 100 according to Embodiment 2 illustrated in FIG. 19 includes components illustrated in FIG. 10 (not illustrated in FIG. 18).

Operation Example

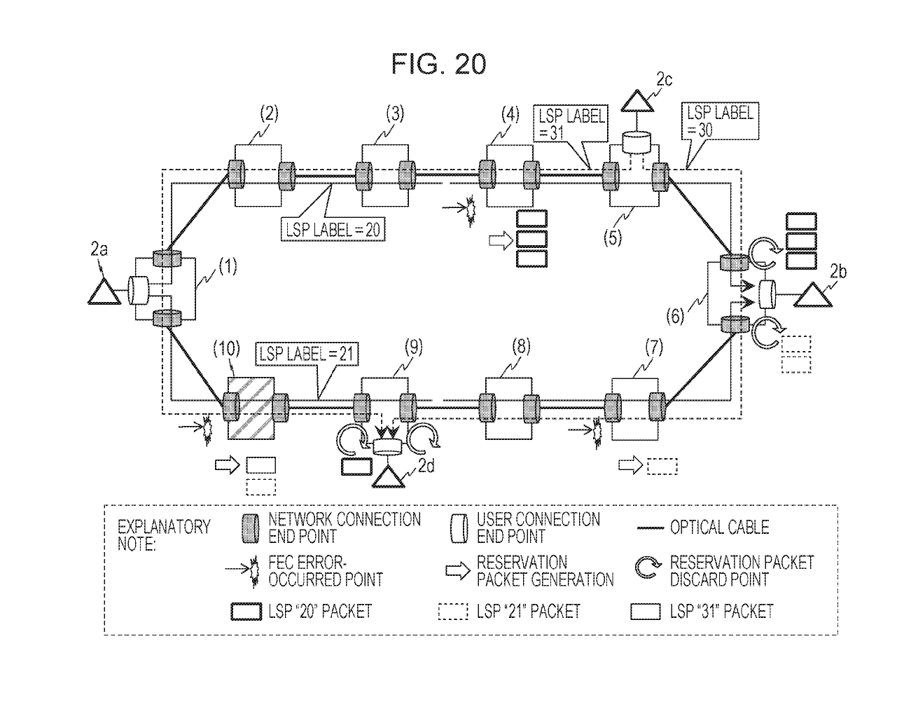

FIG. 20 illustrates an operation example of route switching in a user connection end point associated with the occurrence of a FCS error, in the configuration of the network system illustrated in FIG. 18. In FIG. 20, it is assumed that a FCS error occurs once (for one packet) between the node (1) and the node (10) in the direction from the node (1) to the node (10). Further, it is assumed that the FCS error occurs three times (for three packets) between the node (3) and the node (4) in the direction from the node (3) to the node (4). Further, it is assumed that the FCS error occurs once (for one packet) between the node (8) and the node (7) in the direction from the node (8) to the node (7).

The operation of the node 100 in this case will be described with reference to FIG. 9. It is assumed that the node 100 is a node (10) illustrated in FIG. 20. The node 100 includes a node IF card 101a and an IF card 101b. Slot ID=1 and port ID=1 are set in the IF card 101a, and slot ID=5 and port ID=1 are set in the IF card 101b.

A packet transmitted from the node (1) undergoes FCS check in the PHY/MAC circuit 107 of the IF card 101a (slot ID=1, and port ID=1). As a result, an FCS error is detected once, and the packet is discarded. In this case, the driver 106 notifies the CPU 110 of the control card 102 that the FCS error occurs once at slot ID=1 and port ID=1 by interruption.

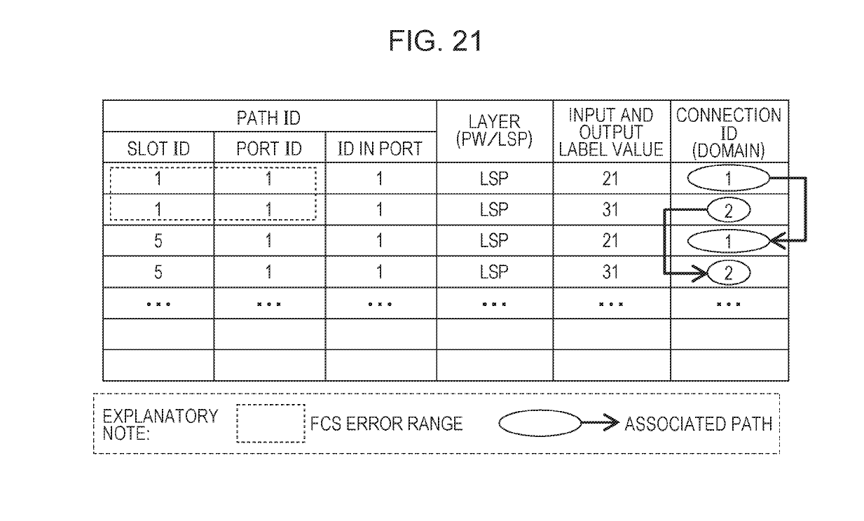

The CPU 110 that has received the notification performs the packet process 113, and searches the path DB (see FIG. 11) for a path related to the FCS error. In this case, the CPU 110 searches for a path, for which the FCS error notification is made, of the path ID (slot ID=1, and port ID=1). Further, paths having a connection ID matching the connection ID (“1” and “2”) of the retrieved path are retrieved as the related path. Here, the path of LSP (LSP “21”) of the label value “21” and the path of LSP (LSP “31”) of the label value “31”, whose path ID is slot ID=5 and port ID=1, are retrieved (see FIG. 21).

The CPU 110 generates a reservation label packet (reservation label value=7) for each retrieved path (see FIG. 16). The CPU 110 instructs the driver 106 of the IF card 101b to transmit the reservation label packet. The driver 106 instructs the packet processing circuit 108 to transmit the reservation label packet. The packet processing circuit 108 transmits the reservation label packet to the adjacent node (9) through the optical transmitter and receiver module 104.

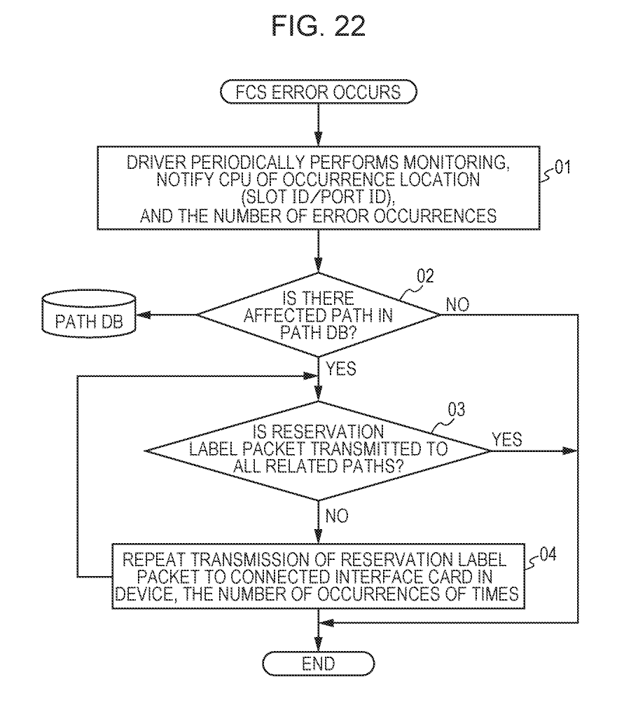

FIG. 22 is an operational flowchart illustrating an example of FCS error detection process of the node 100. In FIG. 22, when an FCS error occurs, the driver 106 notifies the CPU 110 of the occurrence location of the FCS error (slot ID and port ID), and the number of error occurrences (01). As long as a card is uniquely identified, the slot ID may be a card ID (identification information of the card).

In the next 02, the CPU 110 determines whether or not there is a path affected by the FCS error with reference to the path DB. When there is no affected path, the process is ended. In contrast, when there is an affected path, the process proceeds to 03.

In 03, the CPU 110 determines whether or not the reservation label packet is transmitted to all the paths related to the FCS error (affected). When the reservation label packet is transmitted to all the paths, the process is ended.

In contrast, when the reservation label packet is not transmitted to all the paths, the reservation label packet is transmitted to the IF card on the output side (04). The transmission of the reservation label packet is performed for each path. In other words, the reservation label packet of LSP “21” and PW “7” and the reservation label packet of LSP “31” and PW “7” are generated, and transmitted to the IF card 101b. The transmission of the reservation label packet is repeatedly performed the number of occurrences of times. However, since the number of occurrences of the FCS error detected at the node (10) is 1, the transmission of the reservation label packet is performed only once.

Further, an example is illustrated in which the interrupt notification of the driver 106 is periodically performed, in the process of FIG. 22. However, the interrupt notification may be performed in real-time. In other words, the reservation label packets of the number according to the number of occurrences of FCS errors that have occurred during the one period may be transmitted periodically, and the reservation label packet may also be transmitted every time the FCS error occurs.

The same FCS error detection process as the node (10) is performed in the node (4) and the node (7) illustrated in FIG. 20, the reservation label packets corresponding to the number of FCS errors is generated and transmitted for each path, switching corresponding to the destination of the reservation label packet is performed in the node that has received the reservation label packet, and a packet is transferred to the target device. The switching is performed by the SW card 103, according to the LSP label contained in the reservation label packet.

Next, the operation of the target node (for example, the node (6) illustrated in FIG. 20) after receiving the reservation label packet will be described with reference to FIG. 10. The node (6) includes an IF card 101a, an IF card 101b, and an IF card 101c. The IF card 101a is connected to the node (5) illustrated in FIG. 20, where slot ID=10 and port ID=1. The IF card 101b is connected to the node (7) illustrated in FIG. 20, where slot ID=11 and port ID=1. The IF card 101c is connected to an external IP device 2b illustrated in FIG. 20, where slot ID=5 and port ID=1.

The reservation label packet received from the node (5) is input from the optical transmitter and receiver module 104 (network connection end point) to the packet processing circuit 108 through the PHY/MAC circuit 107. In the packet processing circuit 108, after the process of the port control circuit 116 is performed, the packet filtering process by the filter 117 is performed.

The reservation label packet is consistent to the fourth condition from the top of the operation table (see FIG. 12). Therefore, the filter 117 performs a discarding process of the reservation label packet, and increments the discarded reservation packet counter 119 of the IF card 101a.

Similarly, the process by the filter 117 is also performed on the reservation label packet received at the IF card 101b (slot ID=11, port ID=1) from the node (7), and the number of discarded packets is recorded in the discarded reservation packet counter 119.

The CPU 110 in the control card 102 performs the monitoring control 115, instructs the respective drivers 106 of the IF card 101a and the IF card 101b to read out the counter value of the discarded reservation packet counter 119, with respect to a path having a redundant configuration in the path DB. Thus, the CPU 110 obtains the counter value of each discarded reservation packet counter 119.

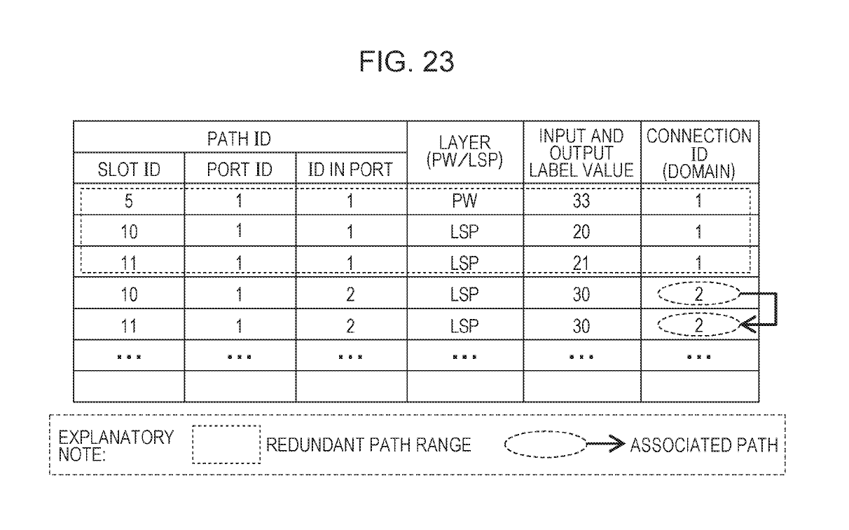

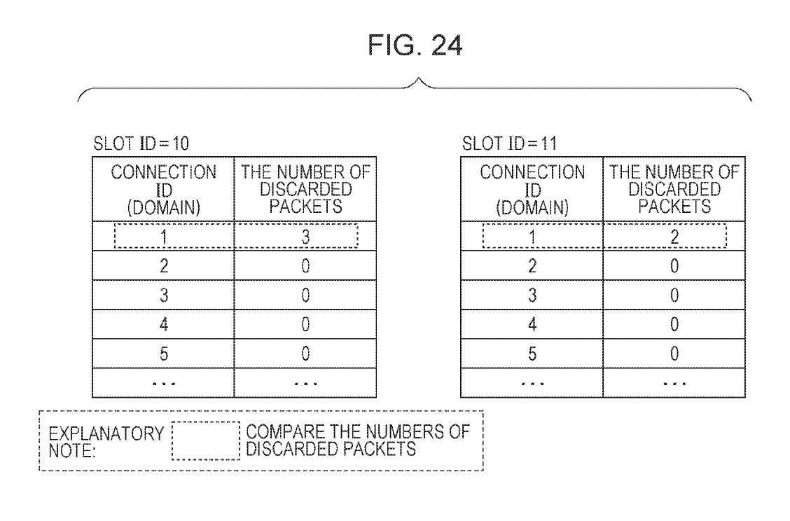

FIG. 23 illustrates a state of the path DB of the node (6), and FIG. 24 illustrates a state of a discarded reservation packet counter of an IF card 101a (slot ID=10) and an IF card 101b (slot ID=11).

As illustrated in FIG. 23, the CPU 110 identifies paths for which the common connection ID (domain) “1” is stored as the range of the redundant path. In other words, LSP “20” and LSP “21” are identified as a pair of paths employing the redundant configuration, and PW “33” is identified as the PW label value common to LSP “20” and LSP “21”. Further, the CPU 110 is able to identify paths for which the connection ID (domain) “2” is stored as the paths related to each other. Further, as illustrated in FIG. 24, in the IF card 101a (slot ID=10), the number of discarded packets is “3” for domain “1”, whereas, in the IF card 101b (slot ID=11), the number of discarded packets is “2” for domain “1”.

The CPU 110 determines to select a signal (a packet of LSP “21”) from the IF101b of the slot ID=11 and port ID=1 (the number of discarded packets 2) having the smaller number of discarded packets, by comparing the numbers of discarded packets obtained from the respective drivers 106, as a process of the monitoring control 115. In other words, the lower route is selected as the active route.

In this case, the CPU 110 gives a control instruction of the transmission circuit 118 to the drivers 106 of the IF card 101a and the IF card 101b. The driver 106 of the IF card 101a changes the state of the transmission circuit 118 so as to discard the packet (LSP “20”) received at the transmission circuit 118.

In contrast, the driver 106 of the IF card 101b changes the state of the transmission circuit 118 so as to transmit the packet (LSP “21”) received at the transmission circuit 118 to the SW card 103. This allows the node (6) to selectively transmit the packet of LSP “21” to the IP device 2b. The switching of a path for the node (6) is performed as mentioned above. Similarly, the node (9) of FIG. 20 also selects the path of LSP “30” having the smaller number of discarded packets. In other words, the active route is switched from the right route to the left route.

In addition, in Embodiment 2, an example in which “7” is used as the reservation label value has been described. However, from the view point of management of the reservation label value, for example, “16” that is a label value outside the definition may be used as the reservation label value. In this case, the value of the reservation label value (PW label) of the reservation label packet transmitted from the node (10) is set at “16”. Further, the PW label value in the fourth entry from the top of the operation table (FIG. 12) is defined as “16”. Then, a setting is performed in which the PW label value “16” is not used in the normal path setting.

Also in Embodiment 2, it is possible to achieve the same effects as Embodiment 1. In other words, the node (10) of FIG. 20 transmits the reservation label packet to the node (6) and the node (9) which are the end nodes of LSP “21” and LSP “31” related to LSP “20”, when the FCS error of the packet of LSP “20” is detected. The reservation label packet is an example of “information indicating the occurrence of an error”. The node (6) may select a route by comparing the counter value corresponding to LSP “20” with the counter value corresponding to LSP “21”. Further, the node (9) also may select a route by comparing the counter value corresponding to LSP “30” with the counter value corresponding to LSP “31”.

### Embodiment 3

Next, Embodiment 3 will be described. Since Embodiment 3 has a configuration common to the configurations of Embodiments 1 and 2, a description regarding the common configuration will be omitted. In Embodiments 1 and 2, the node (the end node in a path) that performs the route selection selects the route having a small number of FCS errors (the number of discarded packets of the reservation label packet) as an active route.

In Embodiment 3, the occurrence prediction number of the FCS error indicating the predicted number of occurrences of the FCS error is calculated for each of paths. Then, when the result of comparing the numbers of discarded packets of the reservation label packets, which are caused by the FCS error occurrences of the paths having a redundant configuration, falls within the difference in the occurrence prediction number, the switching operation is avoided. Thus, it is possible to suppress that the unnecessary switching occurs frequently in a short period of time, and a service is momentarily interrupted.

In Embodiment 3, the comparison period of the number of discarded packets of the reservation label packet and the occurrence prediction number are calculated by the following equation.

Comparison period=a sufficiently long certain time for FCS error occurrence frequency

Occurrence prediction number=Σᵢ₌₀ⁿFCS error occurrence rate [pieces/comparison period] Expression 1

where n=the number of relay devices of path.

In Embodiment 3, in the monitoring control 115 executed by the CPU 110, the count value of the counter 119 is read out at a certain period, and is compared with the number of discarded packets (error occurrence count). At this time, when a difference in the number of discarded packets between the active route and the redundant route (alternative route) exceeds the occurrence prediction number, it is determined to perform the switching of the route. In Embodiment 3, the number of the cumulative FCS error is initialized (reset) for each comparison period (the count value of the counter 119).

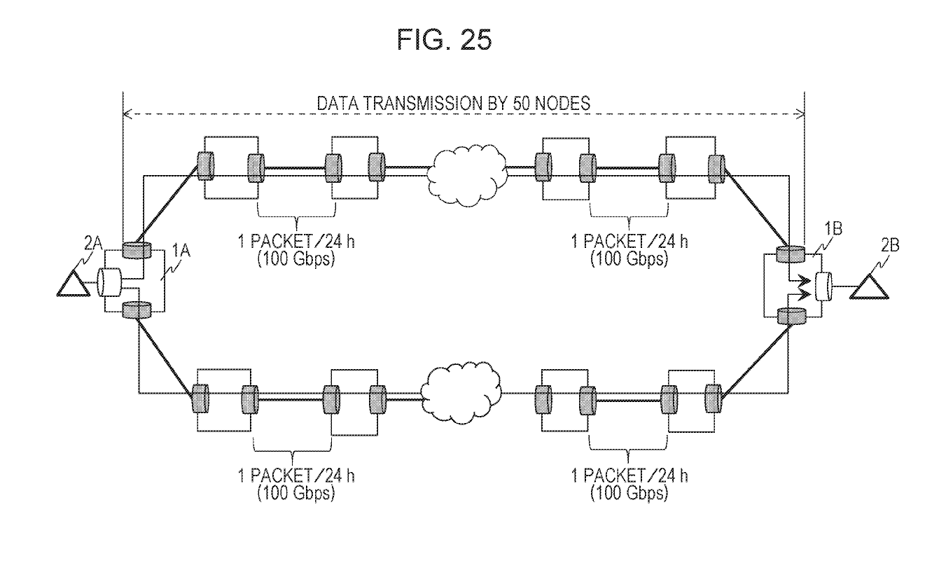

FIG. 25 illustrates a configuration example of a network system according to Embodiment 3. As illustrated in FIG. 25, a plurality of nodes are connected in a ring shape through the optical cable (optical fiber). 50 nodes (relay nodes) are present in each of the upper route and the lower route, between the node 1A connected to the IP device 2A and the node 1B connected to the IP device 2B. Paths are set in each of the upper route and the lower route, between the node 1A and the node 1B, and these paths form redundant paths.

Further, communication of about 100 Gbps is normally performed between the interfaces connecting nodes, and it is assumed that the FCS error of about one packet may occur in 24 hours. It is also assumed that the FCS error occurs at the same frequency between all interfaces.

In the example illustrated in FIG. 25, the comparison period is 24 hours, and the occurrence prediction number is Σᵢ₌₀ⁿ1=50. It is assumed that the path of the upper route in FIG. 25 is selected as the active system (active route) at the node 1B.

When the FCS error intensively occurs in a short period of time in the path of the upper route by chance, the numbers of discarded packets in the upper path and the lower path which appear in the node 1B are temporarily the upper route: 50, and the lower route: 0. In this case, since the occurrence prediction number does not exceed 50, the CPU 110 does not perform the switching of the active system. That is because, if there are no problems with this network, the FCS error also occurs in the path of the lower route with the passage of time, such that it is considered that a difference in the numbers of discarded packets gradually narrows with the passage of time. When difference of detected errors between the upper route and the lower route finally becomes the occurrence prediction number or more, it means that errors of the expected value or more have occurred, and the switching of the active system is performed.

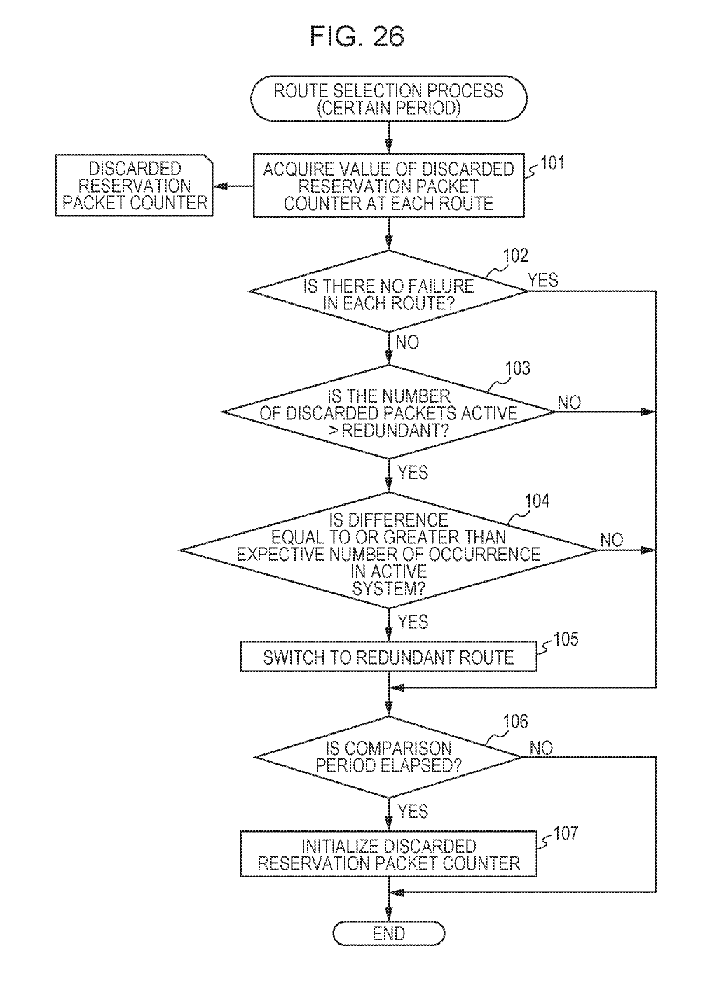

FIG. 26 is an operational flowchart illustrating an example of a route selection process according to Embodiment 3. First, in 101, the CPU 110 (monitoring control 115) acquire the counter value of the discarded reservation packet counter for each of routes.

In the next 102, the CPU 110 determines whether or not there is a failure (discarded packet) in each route. When there is no failure (Yes in 102), the process proceeds to 106. In contrast, when there is a failure (discarded packet) (No in 102), the process proceeds to 103.

In the next 103, the CPU 110 determines whether or not the number of discarded packets of the active system is more than the number of discarded packets of the redundant system (standby system). When the number of discarded packets of the active system is more than the number of discarded packets of the redundant system (standby system) (Yes in 103), the process proceeds to 104; in other case (No in 103), the process proceeds to 106.

In the next 104, the CPU 110 determines whether or not a difference in the numbers of discarded packets is the occurrence prediction number of the active system or more. In this case, when the difference in the numbers of discarded packets is the occurrence prediction number or more (Yes in 104), the process proceeds to 105; in other case (No in 104), the process proceeds to 106.

In the next 105, the CPU 110 switches the active route to the redundant route, and the process proceeds to 105. In 106, the CPU 110 determines whether or not a predetermined comparison period has elapsed. When the comparison period has not elapsed (No in 106), the process is completed. When the comparison period has elapsed (Yes in 106), the CPU 110 initializes the discarded reservation packet counter 119 (107). In other words, the CPU 110 gives a reset instruction to each driver 106, so as to cause each driver 106 to initialize the discarded reservation packet counter 119.

According to Embodiment 3, it is possible to avoid the switching between the active system and the standby system from occurring frequently at a short period of time, and to suppress that a service is momentarily interrupted. The configurations of the embodiments described above may be combined as appropriate.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A node through which a plurality of paths pass, the node comprising:
a receiving port configured to receive packets transmitted through the plurality of paths;
a memory configured to store information on the plurality of paths;
a controller configured to, when an error is detected in a packet received via the receiving port, perform a process of transmitting error information indicating occurrence of an error to respective end nodes terminating the plurality of paths, by using the information on the plurality of paths.

2. The node of claim 1, wherein
a packet is configured to include first and second labels for storing identification information of a path; and
for each of the plurality of paths, the controller generates, as the error information, an error notification packet that includes the first label having a first label value identifying one of the plurality of paths, and the second label having a second label value that is not in use and indicating occurrence of an error.

3. The node of claim 2, wherein
the controller generates and transmits the error notification packet each time an error is detected.

4. The node of claim 2, wherein
the first label value is a label value of a label switched path (LSP) in a multi-protocol label switching-transport profile (MPLS-TP), and the second label value is a label value of a pseudo wire (PW) in the MPLS-TP.

5. A node terminating first and second paths which are set between a start node and the node in a redundant configuration, the node comprising:
a first receiver configured to receive, from a first relay node through which the first path passes, first error information indicating occurrence of an error of a packet caused by a first set of paths passing through the first relay node;
a second receiver configured to receive, from a second relay node through which the second path passes, second error information indicating occurrence of an error of a packet caused by a second set of paths passing through the second relay node; and
a controller configured to select one of the first and second paths, by using a first error-occurrence number indicating a number of receptions of the first error information from the first relay node, and a second error-occurrence number indicating a number of receptions of the second error information from the second relay node, wherein
the first receiver receives, as the first error information, error information that indicates occurrence of an error in any one of the first set of paths and is transmitted from the first relay node to respective end nodes terminating the first set of paths; and
the second receiver receives, as the second error information, information that indicates occurrence of an error in any one of the second set of paths and is transmitted from the second relay node to respective end nodes terminating the second set of paths.

6. The node of claim 5, wherein
the controller calculates a predicted error-occurrence number indicating a predicted number of occurrences of an error related to currently selected one of the first and second paths, and avoids switching from the currently selected one of the first and second paths when a difference between the first error-occurrence number and the second error-occurrence number is less than the predicted error-occurrence number.

7. The node of claim 5, wherein
the first receiver receives, as the first error information, a first error notification packet including a first label having a first label value identifying the first path, and a second label having a second label value indicating occurrence of an error, from the first relay node; and
the second receiver receives, as the second error information, a second error notification packet including the first label having a first label value identifying the second path, and the second label having a second label value indicating occurrence of an error, from the second relay node.

8. The node of claim 7, wherein
the first and second receivers discard the first error notification packet and the second error notification packet, respectively; and
the controller selects one of the first and second paths, by using a number of the first error notification packets that have been discarded by the first receiver and a number of the second error notification packets that have been discarded by the second receiver.

9. A network system comprising:
an end node terminating a plurality of paths; and
a plurality of relay nodes each of which at least two of the plurality of paths pass through, each of the plurality of relay nodes including:
a receiving port configured to receive packets to be transmitted through the at least two of the plurality of paths,
a memory configured to store information on the at least two of the plurality of paths, and
a controller configured to, when an error is detected in a packet received via the receiving port, perform a process of transmitting error information indicating occurrence of an error to respective end nodes terminating the at least two of the plurality of paths, wherein
the end node is configured to terminate first and second paths of the plurality of paths that are set between a start node and the end node in a redundant configuration; and
the end node includes:
a first receiver configured to receive, from a first relay node through which the first path passes, first error information indicating occurrence of an error of a packet caused by the at least two of the plurality of paths including the first path,
a second receiver configured to receive, from the second relay node through which the second path passes, the second error information indicating occurrence of an error of a packet caused by the at least two of the plurality of paths including the second path, and
a controller configured to select one of the first and second paths, by using a first error-occurrence number indicating a number of receptions of the first error information from the first relay node, and a second error-occurrence number indicating a number of receptions of the second error information from the second relay node.

10. A method for notifying occurrence of an error of a packet, the method comprising:
causing a node including a receiving port configured to receive packets transmitted through a plurality of paths:
to store information on the plurality of paths, and
to, when an error is detected in a packet received via the receiving port, transmit error information indicating occurrence of an error to respective end nodes terminating the plurality of paths, by using the information on the plurality of paths.

11. A method for selecting one of first and second paths which are set between a start node and an end node, the method being performed by the end node, the method comprising:
causing the end node:
to receive, from a first relay node through which the first path passes, first error information indicating occurrence of an error of a packet caused by a first set of paths passing through the first relay node,
to receive, from a second relay node through which the second path passes, second error information indicating occurrence of an error of a packet caused by a second set of paths passing through the second relay node, and
to select one of the first and second paths, by using a first error-occurrence number indicating a number of receptions of the first error information from the first relay node, and a second error-occurrence number indicating a number of receptions of the second error information from the second relay node, wherein
the end node receives, from the first relay node, the first error information that indicates occurrence of an error in any one of the first set of paths and is transmitted from the first relay node to respective end nodes terminating the first set of paths; and
the end node receives, from the second relay node, the second error information that indicates occurrence of an error in any one of the second set of paths and is transmitted from the second relay node to respective end nodes terminating the second set of paths.
